(19) United States
(12) Patent Application Publication
(10) Pub. No.: US 2009/0213478 A1
(43) Pub. Date: Aug. 27, 2009

(54) OPTICALLY ACCESSIBLE COVER

(75) Inventors: Cordula Kroll, Tangstedt (DE); Thomas Uschkureit, Henstedt-Ulzburg (DE)

Correspondence Address: King Spalding LLP, 4 Embarcadero Center, Suite 3500, San Francisco, CA, 94111, US

(73) Assignee: Eppendorf AG, Hamburg (DE)

(21) Appl. No.: 12/139,353

(22) Filed: Jun. 13, 2008

Related U.S. Application Data
(60) Provisional application No. 60/944,121, filed on Jun. 15, 2007.
(60) Provisional application No. 61/029,107, filed on Feb. 15, 2008.

(51) Int. Cl. G02B 7/02

(52) U.S. Cl. 359/820

(57) ABSTRACT

The present invention relates to a means for covering and to a device for performing processes and/or reactions involving at least one sample, which are conducted in a temperature-controlled environment and which require optical access to at least one sample.

### CROSS-REFERENCE TO RELATED APPLICATIONS

This application claims priority to U.S. provisional patent application Ser. No. 60/944,121 filed 15 Jun. 2007, and U.S. provisional patent application Ser. No. 61/029,107 filed 2 Feb. 2008, which are incorporated herein in their entirety by reference.

### STATEMENT OF THE INVENTION

The present invention relates to a means for covering and to a device for performing processes and/or reactions involving at least one sample, which are conducted in a temperature-controlled environment and which require optical access to at least one sample.

### BACKGROUND OF THE INVENTION

EP 1 539 353 describes a cover for a biological testing device comprising a heated platen defining a plurality of optical openings. The optical openings are realized as simple through-holes and are configured to permit radiation to pass through the heated platen. The heated platen has a first side configured to face away from a plurality of sample wells and a second side configured to face toward the plurality of sample wells. The heated platen also includes a light transmissive slip cover configured to cover at least one of the plurality of optical openings on the first side of the heated platen. In the embodiment disclosed in EP '353, this “slip cover” is realized as an optically transparent plate made of plastic or glass, covering and therefore optically connecting all optical openings

U.S. Pat. No. 6,043,880 and U.S. Pat. No. 6,597,450 disclose an optical scanning apparatus comprising a plurality of light emitting devices, such as light emitting diodes, which each emit light through a respective optical fiber toward a respective fluid sample in a plurality of fluid samples in a time-staggered manner. Therefore, radiation is generated in each of the fluid samples in response to the excitation light at different times corresponding to the times at which the light is transmitted to the samples.

The focus of U.S. Pat. No. '880 and U.S. Pat. No. '450 is to provide a single detector which can detect the light emitted from a plurality of samples because the light is emitted from each sample at a different time. The apparatus further includes a plurality of bifurcated optical cables, from which excitation light can be emitted toward corresponding samples, and into which light emitted from the samples in response to the excitation light can be received and provided to a single detector.

U.S. Pat. No. 4,652,127 relates to an apparatus for measuring the optic characteristics of liquid samples contained within a set of cuvettes. The apparatus comprises a lower heating surface and an upper heating surface (platen). The device further comprises a first heat source disposed below the cuvettes and horizontally thereto and a second heat source disposed above the cuvettes and also horizontally thereto. U.S. Pat. No. '127 is mostly concerned about establishing a temperature gradient along the cuvettes and preventing condensation by means of such temperature gradients.

WO 2002/41999 relates to a method for counteracting the condensation of substances on an (optically) transparent cover by means of covering each well in an array of wells which forms a test plate having a lower side formed by the bottoms of the wells and an upper side formed by the upper edges of the wells. Onto these edges, a covering film is sealingly attached. Furthermore, a test plate is placed onto the film, with the lower surface of the plate contacting a cooling plate which is kept at a set temperature below room temperature and with the upper surface being positioned at a set distance from a heating plate, which is kept at a set temperature higher than room temperature.

US 2006/0008897 relates to an optical system for focusing light onto one or more samples in a system for biological testing. According to one embodiment, a matrix of lenses is provided, however, not as an integral part of the means for covering as the “heated cover is configured to receive the lens” (column 2, paragraph [0038]).

Similar to what was discussed above in regard to US 2006/0008897, US 2006/0221336 mentions an array of focusing lenses/collimating lenses (column 4, [0043]), these are not provided as a part of the means for covering.

U.S. Pat. No. 6,852,986 relates to a fluorometer comprising a plurality of low heat-generating light sources and means for positioning a plurality of sample containers into optical communication with said light sources. This fluorometer may be combined with a thermal cycler. The thermal cycler has a “thermally controlled cover having a plurality of apertures corresponding to each sample tube”. Since said apertures are open (air-filled), condensation problems may arise in the optical system of the fluorometer.

In summary, one of the disadvantages of the embodiments of the prior art is that rigid platens are provided as part of the means for covering, having open (air-filled) through-holes for optical access. This leads to known problems associated with platen deformation, in particular in case the platen is too thin. Problems of deformation are exacerbated by adding an array of holes to the platen.

Furthermore, the air-filled through-holes/borings also may lead to residual scattering and spurious radiation as generated by the rims and edges of the borings. This problem can only be partially solved by means of conical borings as described in the prior art.

Another disadvantage of the prior art are problems associated with inhomogeneities in respect to thermal contact and/or thermal isolation. In particular, open holes for optical access may act as thermal “chimneys” leading to problems in regard to condensation of vaporizable sample components on the platen/cover/lid and/or loss of vaporizable substances by means of evaporation. In particular, open holes in the means for covering the samples, for example the platen, lead to potential condensation of vaporizable fluids in the optical system as typically situated above said means for covering. This is particularly problematic in case the optical system is cooled.

A possible solution to this “chimney” problem is the insertion of a transparent slip cover between samples and optical system (as suggested in EP 1 539 353). This, however, leads to the collateral problem of optical cross-talk between neighboring samples as mediated by the optically transparent slip cover. In essence, radiation of one sample may interact with reflected/refracted light from a neighboring sample.

### SUMMARY OF THE INVENTION

Therefore, in view of the prior art in the field, it is an object of the present invention to provide a means for covering and a device according to which at least one sample, preferably at least one sample as contained in a vessel, is covered by means for covering in a manner so that the at least one sample is optically accessible, in particular accessible for performing optical measurements, while, at the same time, background radiation, in particular fluorescence and/or light scattering intrinsic to the means for covering is avoided or at least minimized.

Furthermore, it is a preferred object that if more than one sample needs to be optically accessible, for example in case an array of samples is contained in a sample well, optical cross talk between said samples is avoided or minimized.

It is another preferred object of the present invention to provide a means for covering and a device that allows for the application of pressure onto the at least one sample/vessel in order to provide or improve thermal contact between said means for covering and the at least one sample (or the vessel containing said sample) while minimizing potential evaporation of the sample or components of the sample and/or condensation of vaporizable fluids of said sample on said means for covering and/or on the optical system as potentially situated above the sample. The means for covering should also preferably achieve improved thermal contact between sample vessels, in case sample vessels are present, and the surrounding means for accommodating.

In particular, inhomogeneities in respect to evaporation and/or of condensation between different vessels/wells in an array of vessels or wells should be avoided/minimized. The latter applies in particular if a plurality of samples and/or vessels/wells is covered by means for covering that essentially correspond to a plate/platen.

These and other objects are solved by means for covering at least one sample, preferably at least 12 samples, further preferably at least 48 samples, further preferably at least 96 samples, further preferably at least 384 samples, wherein said means for covering comprise at least one optical coupling path, preferably at least 12 optical coupling paths, further preferably at least 48 optical coupling paths, further preferably at least 96 optical coupling paths, further preferably at least 384 optical coupling paths, wherein at least one, preferably all optical coupling path(s) comprise(s) a material that has an index of refraction greater than the index of refraction of air and/or that has a density greater than the density of air, both measured at standard temperature (20° C.) and pressure (1 atm).

In the present invention, the “means for covering” is the unit that closes at least one sample and is capable of exerting or mediating pressure onto at least one sample and/or the vessel in which the sample is contained. Such means for covering may also be known as “plate” or “platen” or “cover”. While a means for covering essentially in the shape of a plate is preferred, a non-plate-like shape of the means for covering and/or a multi-component or multi-plate assembly is also part of the present invention.

It is preferred that the optical system as required for exciting and/or recording radiation is situated above said means for covering. In an alternative embodiment, the optical system is part of the means for covering.

The term “radiation” as used throughout this application preferably comprises fluorescence, transmitted radiation, luminescence, absorbed, emitted and/or scattered light. Turbidity measurements are also included.

In accordance with the present invention, at least one optical coupling path, preferably all optical coupling paths is/are integral with said means for covering.

Further preferably, the at least one optical coupling path extends from the outer surface of the means for covering to the inner surface of said means for covering.

It is further preferred that the means for covering does not comprise any through-holes that serve as optical pathways and/or for optical access extending from the outer surface of the means for covering to the inner surface of the means for covering that could be filled with air or any other medium having a density comparable to the density of air during operation of the means for covering.

It is further preferred that elements of the system, preferably the optical system, to excite and/or record radiation, in particular light sources (diodes, visible light emitting heated devices, lasers etc.) and/or detectors are situated above the outer surface of the optical coupling paths or are in direct optical contact therewith.

In accordance with a preferred embodiment of the present invention, the means for covering comprises at least one means for heating and/or cooling and/or is in immediate physical and thermal contact with at least one means for heating and/or cooling.

In a preferred embodiment of the present invention, said means for covering is part of a device for performing processes and/or reactions that are conducted in a temperature-controlled environment and that require optical access to at least one sample. In addition to the above-described means for covering, said device comprises at least one of the following further components:
at least one means for accommodating at least one sample;
at least one means for heating and/or cooling at least one sample;
at least one optical source;
at least one detector.

It is preferred that the optical source is a device emitting radiation in response to an electrical current, an applied voltage or by means of stimulated emission of radiation (laser). It is further preferred that the optical source delivers electromagnetic radiation comprising at least one wavelength (as measured in 1 nm increments) in the range of 400-800 nm.

It is preferred that the detector is capable of detecting radiation emitted by a fluorescent marker, preferably radiation comprising at least one wavelength (as measured in 1 nm increments) in the range of 400-800 nm.

In accordance with a preferred embodiment of the present invention (relating to the means for covering and the device), the at least one sample is contained in at least one vessel or reaction vessel or in at least one well or dimple or indentation of a plate or a block. Said vessel or plate or block can be disposable or can be an integral part of the device, in particular of the means for accommodating.

The purpose of the optical coupling path(s) as described herein (and a preferred use of the means for covering and of the device) is to allow the observation of radiation emanating from at least one sample and/or to be able to couple optical radiation into the sample, i.e. to excite said sample.

In a further preferred embodiment, the means for covering and/or the device according to the present invention is used for performing temperature sensitive chemical or biological reactions requiring radiation access to at least one sample, preferably for reactions performed in conjunction with nucleic acid amplification, in particular assays based on polymerase chain reaction (PCR). Preferably, the device is or is part of thermal cyclers, plate readers, melting curve analyzers and/or facilitates amplification techniques suitable for real time detection, in particular in the context of quantitative polymerase chain reaction (qPCR) and real time PCR, respectively. The use of qPCR as end point reader is also included.

The device of the present invention is particularly suitable for quantitative polymerase chain reaction (qPCR) and/or real-time polymerase chain reaction, wherein the amount of DNA generated is measured after at least one, preferably after each, cycle of PCR by means of florescent markers.

In accordance with a preferred embodiment of the present invention, the means for covering and the device are used for thermally cycling at least one sample, preferably two or more samples, while continually or intermittently measuring radiation, preferably fluorescence, emanating from one sample and/or transmitted or otherwise relayed by the sample.

### BRIEF DESCRIPTION OF THE DRAWINGS

FIG. 1 is a schematic drawing of a device as described in the prior art (EP 1 539 353).

FIG. 2 shows an embodiment in accordance with a preferred embodiment of the present invention in which an array of lenses is provided that is integral with a heated means for covering.

### DETAILED DESCRIPTION OF THE INVENTION

For the purposes of the present invention, “optical access” is to be understood as the capability of electromagnetic radiation, comprising or consisting of radiation in the visible part of the electromagnetic spectrum, preferably from 400 nm to 800 nm, to interact with at least one sample and/or to emanate from the at least one sample without complete attenuation by means of passing through a means for covering.

In particular, “optical access” includes “optical coupling” with at least one sample so that radiation from or of said at least one sample can be excited and/or observed.

While the present invention is exemplarily discussed in the context of thermal cyclers, plate readers, melting curve analyzers or other amplification techniques suitable for real time detection, and in particular in the context of quantitative polymerase chain reaction (qPCR) and real time PCR, respectively, the means for covering and the device of the invention are not restricted to this specific application but rather relate to all applications known to the per-son skilled in the art in which some kind of sample(s)/mixture(s) need(s) to be handled or held at a certain temperature and the requirement needs to be fulfilled that radiation, preferably radiation in the visible part of the electromagnetic spectrum, is capable of emanating from and/or interacting with said sample.

In accordance with the present invention, the means for covering cover at least one sample, preferably at least 12 samples, further preferably at least 48 samples, further preferably at least 96 samples, further preferably at least 384 samples. Furthermore, said means for covering comprise at least one optical coupling path, preferably at least 12 optical coupling paths, further preferably at least 48 optical coupling paths, further preferably at least 96 optical coupling paths, further preferably at least 384 optical coupling paths, wherein at least one, preferably all optical coupling path(s) comprise(s) a material that has an index of refraction greater than the index of refraction of air and/or that has a density greater than the density of air.

Herein, the term “optical coupling path” is understood to be a connection between the outer surface of the means for covering and the inner surface of the means for covering, which allows at least for partial transition of electromagnetic radiation comprising wavelengths from 400 nm to 800 nm, i.e. visible light, from the outside of the (closed) means for covering to the inside of the means for covering, thus reaching or emanating from at least one sample.

Therein, the “outer surface” of the means for covering is understood to be the surface of the means for covering that is essentially directed towards the user of a device comprising said means for covering. Correspondingly, the “inner surface” of the means for covering is understood to be the surface of the means for covering that is essentially directed towards the at least one sample.

In accordance with the present invention, no restrictions exist in regard to the optical coupling path(s), except that said optical coupling path(s) need(s) to comprise a material that has an index of refraction greater than the index of refraction of air and/or that has a density greater than the density of air as measured at standard temperature (20° C.) and pressure (1 atm) and a wavelength of 520 nm.

In accordance with a preferred embodiment of the present invention, the index of refraction of the at least one optical coupling path at standard temperature and pressure and at a wavelength of 520 nm is greater than 1.1, preferably greater than 1.2, further preferably greater than 1.3, further preferably greater than 1.4.

In accordance with a preferred embodiment of the present invention, the density of the at least one optical path at a temperature of 20° C. and standard pressure (1 atm) is greater than 1.5 kg/m3, preferably greater than 10 kg/m3, further preferably greater than 100 kg/m3, further preferably greater than 1000 kg/m3, and further preferably greater than 2000 kg/m3.

In accordance with a preferred embodiment of the present invention, at least one optical path is realized as a means that facilitates the focusing, expanding or collimating of electromagnetic radiation, preferably radiation in the wavelength range from 400 to 800 nm (optical lens). Further preferably, said optical lens is capable of focusing said radiation. At least one, preferably all optical lenses may be coated with a reflection-reducing coating or any other type of coating known in the art.

If a plurality of optical lenses is part of the means for covering, said optical lenses are preferably arranged in the form of an array or a matrix. Further preferably, said array of lenses is an integral part of the means for covering.

In accordance with a preferred embodiment of the present invention, at least one optical path comprises a polymer material having an index of refraction at standard temperature and pressure and at a wavelength of 520 nm that is greater than 1.1, preferably greater than 1.2, further preferably greater than 1.3, further preferably greater than 1.4. Resin plastic or polymeric materials are preferred as they intrinsically have or lead to low residual fluorescence and/or light scattering.

In accordance with a preferred embodiment of the present invention, at least one optical coupling path transmits at least 25% of the radiation as entering on either side of the optical coupling path, wherein said “radiation” comprises at least one wavelength (i.e. a 1 nm interval) in the range from 400 to 800 nm, preferably all wavelengths. Further preferably, at least 50% of said radiation is transmitted, further preferably at least 75%, further preferably at least 90%.

“Transmission” in this context means that said radiation enters the means for covering on one side (“inside surface” or “outside surface”), defined as having an intensity of a full 100% at this location and exits on the respective other side of the means for covering with the attenuation as given in percent.

According to a preferred embodiment of the present invention, the means for covering, preferably a heated platen, comprises at least one segment or area that is transparent in the optical part of the electromagnetic spectrum. The spectral range is chosen so that transparency for electromagnetic radiation exists in the wave length range from 200 nm to 1000 nm, preferably 300 nm to 900 nm, and particularly preferably 250 nm to 800 nm. The transparent area or segment is selected from the group consisting of cylinder-shaped openings that run through the entire means for covering; openings that taper (narrow) in respect to the upper side of the means for covering/platen and that are running through the entire means for covering/platen; cylinder-shaped openings that run through the means for covering/platen over the entire thickness of the same, wherein a transparent body is inserted into said cylinder-shaped openings; openings that taper (narrow) in respect to the upper side of the means for covering/platen and that run through the means for covering/platen over the entire thickness of the same, wherein a transparent body is inserted into said tapering (narrowing) openings. The transparent body is preferably an optical lens such as, for example, a liquid lens, an intelligent lens or a Fresnel lens. Alternatively, the transparent body is not a lens but rather a transparent body that is adapted to the shape of the opening, wherein said transparent body is, for example, a cylinder or a tapered cylinder that does not serve the purpose of optical imaging. The transparent body and in particular the openings that are filled with said transparent body have the advantage that by means of selecting the type of the transparent body, the strength and the quality of the exiting and/or the emitted signal can be effected.

In accordance with a preferred embodiment of the present invention, at least one optical coupling path, preferably all optical coupling paths is/are integral with the means for covering, and in particular integral with the material(s) surrounding the at least one optical coupling path.

For the purposes of the present invention, an optical coupling path is integral with the means for covering when no physical gap exists, within measuring tolerances, between said at least one optical coupling path and the surrounding material of said means for covering.

From this, it follows that at least one, preferably all, optical coupling path(s) remain(s) in the same position with respect to said means for covering during operation of the overall device comprising said means for covering, in particular during opening and closing of said means for covering and during optical measurements performed while the means for covering covers the at least one sample. In particular, no assembly/disassembly is required in respect to the optical coupling paths(s) and the means for covering.

In accordance with a preferred embodiment of the present invention, the material for the optical path(s) is different from the surrounding material of the means for covering. It is preferred that said difference manifests itself at least in regard to one of the following material characteristic: difference in regard to % transmission, difference in regard to index of refraction and/or difference in regard to density.

In a preferred embodiment, the material surrounding the at least one optical path transmits less than 1% of the radiation potentially entering on either side of the means for covering for at least one wavelength (i.e. a 1 nm interval) in the range from 400 to 800 nm, preferably at all wavelengths. Further preferably, less than 0.1% of said radiation is transmitted, further preferably less than 0.01%.

It is particularly preferred that the optical coupling path(s) is/are made of a material that is essentially transparent for visible light, while the surrounding material, preferably the entire remainder of the means for covering is made of an essentially non-transparent material, preferably a material that has a grey or black appearance to the average human eye. This optical mismatch of materials should preferably lead to a cross-wise “optical decoupling” between adjacent optical coupling paths.

It is also conceivable that the optical coupling path, while essentially transparent, comprises components that selectively absorb and/or reflect certain wavelengths/wavelength ranges thus preferably imparting some coloring.

As a technical effect, decoupling the optical coupling paths from each other, in particular by providing a different, essentially non-transparent material in between the optical coupling paths, optical cross talk between individual optical coupling paths is minimized or avoided altogether.

Furthermore, due to the fact that the optical coupling paths are integral to the means for covering, light scattering and/or residual reflection as typical for the rims of any type of boreholes (filled with air), even conical ones, is minimized or avoided. This holds in particular since no air gap exists between the two optically dense materials, i.e. the optical coupling path according to the present invention and the surrounding means for covering. This smooth “optical compatibility” also minimizes or avoids residual radiation that could potentially interfere with radiation of the samples.

In this context, it is particular preferred that the optical properties of the optical coupling path and of the surrounding materials are chosen so that residual radiation and/or scattering are limited, for example by means of ensuring total internal reflection inside the optical coupling path(s) and/or by matching essentially transparent optical coupling paths with essentially non-transparent surrounding materials.

In regard to manufacturing the means for covering, it is preferred to (mold) inject the material for the optical coupling paths into the template of a body of the means for covering providing the above-described “surrounding material”. This material or these at least two materials are preferably of polymeric nature and the process of manufacture preferably involves die casting, feeder casting, (co)molding, injection molding, (co)injection, (co)extrusion or any combination thereof.

In an alternate preferred embodiment, the means for covering is made of one material that allows for the transmission of light and is masked on the outer and the inner surface, respectively as to define optical pathways.

In accordance with the present invention the means for covering the at least one sample, preferably for covering a plurality of samples, are reinforced as to be better suited for diverting pressure required for closing/covering the sample(s).

As an example, stiffening may be achieved by means of stiffening devices, such as ribs. Alternatively, strengthening and/or stiffening may be achieved by means of an additional metallic of ceramic plate/platen that is preferably grid-like and therefore does not interfere with the optical access. Such strengthening/stiffening is preferred in case the means for covering is essentially a plate.

In accordance with the present invention, no restrictions exist in regard to the at least one sample. The sample can be a single substance, a reaction mixture or any other conceivable material. Blind samples are included. Samples suitable for qPCR, in particular samples comprising a fluorescent marker are preferred.

In a preferred embodiment, the at least one sample is contained in at least on reaction vessel and/or in at least one well/dimple/indentation of a plate, in particular a sample well plate (multititer plate, PCR plate) or a block, in particular a flat block. The sample may also be contained in a consumable/disposable that is placed on a flat block. The reaction vessel, plate or block can be disposable or can be a permanent and/or integral part of the device, in particular of the means for accommodating.

No restrictions exist in regard to the reaction vessels that preferably contain the at least one sample.

The reaction vessels may be closed (i.e. may have a lid or cover or may be covered by a sheet or a film or foil) or then may be open. Open reaction vessels can be used next to closed reaction vessels. Preferred reaction vessels are reaction tubes as known to the person skilled in the art as suitable for conducting PCR, including vessels having a flat bottom. In accordance with the present invention, any lid, cover, sheet, foil or film placed on a reaction vessel is preferably optically transparent as to allow optical investigation of the sample, in particular the excitation and the recording of radiation.

In order to properly seal the reaction vessels, plates or blocks, the means for covering preferably comprise sealing structures, such as, preferably, raised rims around the positions of the optical coupling paths, in particular the optical lenses and/or the positions that correspond to the position of the walls in a sample block. It is preferred that said rims or equivalent structures are elastically deformable.

No restrictions exist in regard to the means for heating and/or cooling. Preferably, the means are capable of heating or cooling at least one sample and/or at least one reaction vessel or plate or block. It is preferred that the means for heating and/or cooling are selected from the group of resistance heater, fluid mediated heating/cooling, air/gas cooling, Peltier heating/cooling, friction (Joule) heating/cooling, and/or radiation heating.

In a preferred embodiment according to the present invention, at least one means for heating and/or cooling at least one sample and/or reaction vessel is part of the means for covering and/or is in thermal and physical contact therewith. In this case, it is preferred that said means for heating and/or cooling minimizes or avoids evaporation of sample and/or minimizes or avoids condensation of vaporized sample on or in the vicinity of the means for covering, in particular on or in the optical coupling paths, which preferably are optical lenses.

In accordance with a preferred embodiment of the present invention, said means for heating and/or cooling that is part of the means for covering is integral with said means for covering during operation, in particular during opening and closing said means for covering and during optical measurements performed while the means for covering covers the at least one sample.

While said means for heating/and or cooling is integral with said means for covering during operation, it is further preferred that said means for heating and/or cooling can be replaced in case of malfunction and/or need for exchange, i.e. it is preferred that said means for heating and/or cooling are replaceably integral to the means for covering.

In regard to said means for heating and/or cooling, it is preferred that they are provided as a heating foil or sheet applied to any or all surface(s) of the means for covering. Heating foils or sheets may also be imprinted onto any or all of the inner or outer surfaces of the means for covering. Printed circuit boards and/or conductor strips are preferred in this context.

Therein, it is preferred that said heating foils or sheets are arranged so that they do not interfere with the optical transmission of the optical coupling paths. Therein, it is preferred that the foils or sheets themselves are sufficiently transparent or that they comprise suitable recesses.

In regard to applying films, sheets or strips of means for heating and/or cooling, backfilling, extruding or co-extruding of materials capable of functioning as resistance heaters and/or as thermally conductive materials is preferred.

Applying Peltier elements in thermal contact with any or all of the inner or outer surfaces of the means for heating is also within the scope of the present invention.

Heating plugs or coils as inserted into corresponding indentations of the means for covering are also preferred.

In regard to the device for thermal processing and optical examination of at least one sample, comprising the means for covering according to the present invention, it is preferred, that an additional means for heating and/or cooling is provided in other units of said device comprising the means for covering, in particular in the means for accommodating a plurality of samples and/or reaction vessels.

No restrictions exist in regard to the means for accommodating at least one sample, which is part of the device according to the present invention. This means may be a holder for reaction vessels or may be a block or a plate, for example a (flat) block made of metal, plastic materials or of composite materials, all of which may comprise wells or dimples or any other type of indentation/containment.

The means for accommodating may be, for example, a (microtiter) plate, a water bath with an insert for holding reaction vessels, a carousel, any other type of multi-well plate or a flat block. Preferably, the means for accommodating are block- or box-shaped. It is preferred that said means are thermally insulated. It is further preferred that the means for accommodating comprise means for heating and/or cooling the reaction vessel(s) and/or the sample(s) from below and/or from the side.

The means for accommodating may be disposable or may be reusable. They may temporarily or permanently be part of a base body, or of any other part of the device according to the present invention.

The means for covering are preferably temporarily or permanently affixed to and/or aligned with the means for accommodating the sample(s) or reaction vessel(s). In this context, it is preferred that means for covering and the means for accommodating share a common base body. Further preferably, the unit comprising means for accommodating and the means for covering (optionally comprising a base body) completely enclose and/or encase the at least one sample or reaction vessel. Complete enclosing and/or encasing improves temperature stability. In accordance with the present invention, optical access to the sample(s) is ensured while temperature stability is maximized.

### DETAILED DESCRIPTION OF THE FIGURES

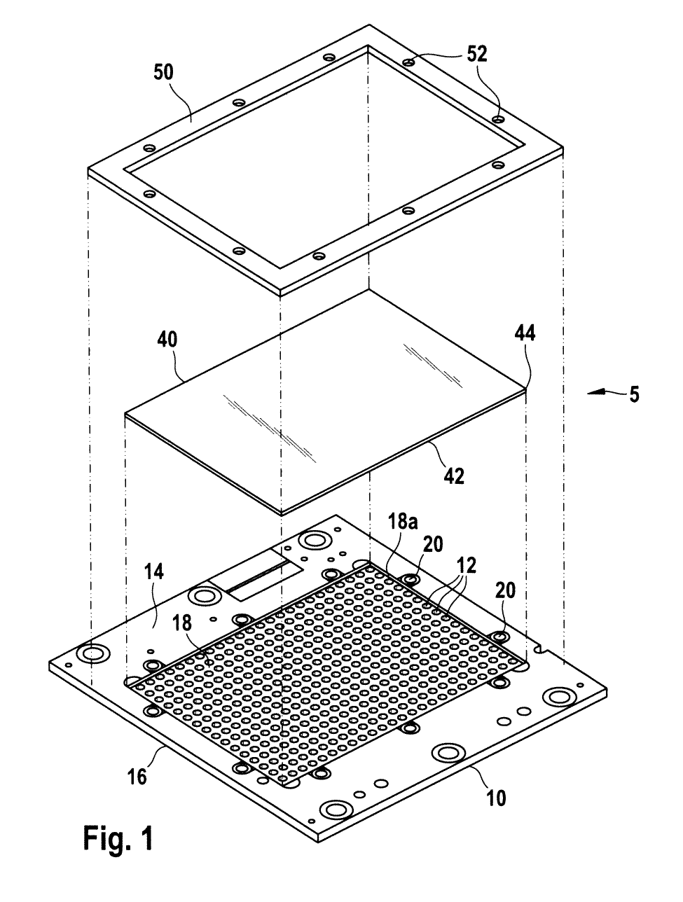

FIG. 1 shows an embodiment as known from the art (EP 1 539 353). A heated platen (10) has optical openings (12) in a recessed area (18). The air-filled optical openings are covered with a slip cover (40). The present invention avoids both the optically transparent slip cover potentially leading to optical cross-talk and the presence of air-filled openings potentially leading to residual radiation and light scattering.

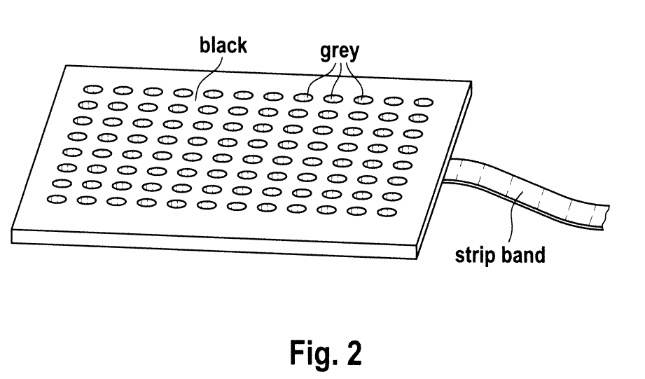

FIG. 2 shows a preferred embodiment according to the present invention. Therein a means for covering a plurality of 96 samples (provided, for example, in a 96 well plate) is shown in the form of a heated platen. The heater as being integral part of the platen is shown schematically by means of a strip band for the electrical connections for the heater (realized, for example, as heating foil). Furthermore, an array of 96 optical lenses (representing the 96 optical coupling paths according to the present invention) is shown (grey oval spots) being integral to the heated platen. The material surrounding the optical lenses (shown in black) is different from the material of the optical lenses.

Preferably, both materials are polymers, wherein the grey material for the optical lenses is essentially transparent while the black material surrounding the lenses is essentially non-transparent.

We claim:

1. Means for covering at least one sample, wherein said means for covering comprise at least one optical coupling path, wherein said at least one optical coupling path comprises a material that has an index of refraction greater than the index of refraction of air and/or that has a density greater than the density of air, characterized in that said at least one optical coupling path is integral with said means for covering.

2. Means for covering according to claim 1, wherein the means for covering essentially has the shape of a plate.

3. Means for covering according to claim 1, wherein the at least one optical coupling path extends from the outer surface of the means for covering to the inner surface of said means for covering.

4. Means for covering according to claim 1, wherein an optical system for exciting and/or recording radiation is situated above said means for covering, while said means for covering is situated above the at least one sample.

5. Means for covering according to claim 1, wherein the means for covering does not comprise any through-holes extending from the outer surface of the means for covering to the inner surface of the means for covering that serve as optical coupling paths and could be filled with air or any other medium having a density comparable to the density of air during the operation of the means for covering.

6. Means for covering according to claim 1, wherein the means for covering comprises at least one means for heating and/or cooling and/or is in immediate physical and thermal contact with one such means for heating and/or cooling.

7. Means for covering according to claim 1, wherein the at least one sample is contained in at least one vessel or reaction vessel or in at least one well or dimple or indentation of a plate or a block.

8. Means for covering according to claim 1, wherein the index of refraction of the at least one optical coupling path at standard temperature and pressure and at a wavelength of 520 nm is greater than 1.1, preferably greater than 1.2, further preferably greater than 1.3, further preferably greater than 1.4.

9. Means for covering according to claim 1, wherein the density of the at least one optical path at a temperature of 20° C. and standard pressure is greater than 1.5 kg/m3, preferably greater than 10 kg/m3, further preferably greater than 100 kg/m3, further preferably greater than 100 kg/m3, and further preferably greater than 2000 kg/m3.

10. Means for covering according to claim 1, wherein said at least one optical coupling path is realized as an optical lens.

11. Means for covering according to claim 1, wherein said means for covering comprises at least 12 optical coupling paths covering at least 12 samples, and wherein at least one optical coupling path comprises a material that has an index of refraction greater than the index of refraction of air and/or that has a density greater than the density of air.

12. Means for covering according to claim 11, wherein all of the optical coupling paths comprise a material that has an index of refraction greater than the index of refraction of air and/or that has a density greater than the density of air.

13. Means for covering according to claim 11, wherein an array of optical lenses is provided that is integral to the means for covering.

14. Means for covering according to claim 1, wherein said at least one optical coupling path transmits at least 20% of the radiation as entering on either side of the optical coupling path, wherein said radiation comprises at least one wavelength within a 1 nm interval in the range from 400 to 800 nm, preferably all wavelengths.

15. Means for covering according to claim 1, wherein the material for the optical path is different from the surrounding material of the means for covering.

16. Means for covering according to claim 15, wherein said difference manifests itself at least in regard to one of the following material properties: difference in regard to % transmission, difference in regard to index of refraction, difference in regard to density.

17. Means for covering according to claim 15 or 16, wherein the two materials are of polymeric nature and the process of manufacture involves die casting, feeder casting, (co)molding, injection molding, (co)injection, (co)extrusion or any combination thereof.

18. Means for covering according to claim 6, wherein the means for heating/and or cooling is selected from the group comprising heating foil or sheet applied to any or all surface(s) of the means for covering, heating foil or sheet as imprinted onto any or all of the inner or outer surfaces of the means for covering, printed circuit boards, conductor strips.

19. A device comprising at least one means for covering according to claim 1 or claim 10, said device further comprising at least one of the following components: 1) at least one means for accommodating at least one sample; 2) at least one means for heating and/or cooling at least one sample; 3) at least one optical source; and 4) at least one detector.

20. Device according to claim 19, wherein the means for heating and/or cooling are selected from the group of resistance heater, fluid mediated heating/cooling, air/gas cooling, Peltier heating/cooling, friction (Joule) heating/cooling, and/or radiation heating.

21. Device according to claim 19, wherein the optical source is a device emitting radiation in response to an electrical current, an applied voltage or by means of stimulated emission of radiation, e.g. a laser, and preferably delivers electromagnetic radiation comprising at least one wavelength, as measured in 1 nm increments, in the range of 400-800 nm.

22. Device according to claim 19, wherein the detector is capable of detecting radiation, preferably radiation comprising at least one wavelength, as measured in 1 nm increments, in the range of 400-800 nm.

23. Use of the device according to claim 19 for the observation of radiation emanating from at least one sample and/or reflected or transmitted by at least one sample, preferably fluorescence.

24. Use according to claim 23 for performing temperature sensitive chemical or biological reactions requiring optical access to at least one sample, preferably for reactions performed in conjunction with nucleic acid amplification, in particular assays based on polymerase chain reaction (PCR), in particular for quantitative polymerase chain reaction (qPCR) and/or real-time polymerase chain reaction, further preferably melting curve analysis and/or other amplification techniques with real time detection, including the use of qPCR as a and/or in an end point reader.
